(19) United States
(12) Patent Application Publication
(10) Pub. No.: US 2011/0191463 A1
(43) Pub. Date: Aug. 4, 2011

(54) MANAGEMENT METHOD FOR INTERNET PROTOCOL SHARING COMMUNICATION MECHANISM

(75) Inventor: REN HAO LIU, HSINCHU COUNTY (TW)

(73) Assignee: RALINK TECHNOLOGY CORPORATION, HSINCHU COUNTY (TW)

(21) Appl. No.: 12/959,763

(22) Filed: Dec. 3, 2010

(30) Foreign Application Priority Data
Feb. 3, 2010 (TW) 099103122

(51) Int. Cl. G06F 15/16

(52) U.S. Cl. 709/224; 709/223

(57) ABSTRACT

A management method for an Internet protocol sharing communication mechanism comprises the steps of: setting up a plurality of rules for an Internet protocol sharing communication mechanism; providing a schedule divided into different time slots; assigning one rule from the rules for the Internet protocol sharing communication mechanism for each time slot of the schedule; and conducting a network communication according to the assigned rules.

### BACKGROUND OF THE INVENTION

1. Field of the Invention

The present invention relates to a method for managing an Internet communication mechanism, and more particularly, to method for managing an Internet protocol sharing communication mechanism.

2. Description of the Related Art

To connect to the Internet, a client, such as a personal computer, often requires an Internet protocol (IP) address to be recognized by other users on the Internet. Generally, an Internet service provider (ISP) will provide a user one or several IP addresses. Accordingly, end user might need to buy an IP sharing device if the number of physical IP addresses is not sufficient. However, an IP sharing communication mechanism, such as an IP router, can satisfy the user's requirement.

An IP sharing communication mechanism can generate a plurality of virtual IP addresses based on a single physical IP address to allow several clients to connect to the Internet simultaneously. Since these clients actually connect to the Internet based on one or more physical IP addresses, they need to share the network bandwidth. For example, for other users on the Internet, the connection to the Internet via an IP router is done using a single physical IP address. Therefore, the IP router requires a processer unit to process the transmission and reception of packets. The processer unit can decide the destination of the packets transmitted by the IP router and the client to which the packets received by the IP router belong.

Current IP sharing communication mechanisms only process the transmission and reception of packets for the clients they support, but fail to restrict or adjust the usable network bandwidth in accordance to the properties of these packets. However, some applications may occupy most of the network bandwidth. For example, the popular peer to peer (P2P) transmission applications occupy most of the network bandwidth. FIG. 1 shows that a network bandwidth shared by a plurality of clients is occupied by a client using a P2P transmission application. Therefore, there is little network bandwidth remaining to be shared with other clients, which cause the transmission quality to downgrade.

In view of the increasing attention of Internet users on the quality of service (QoS) of network connection, several IP sharing communication mechanisms make some improvement. FIG. 2 shows another network bandwidth shared by a plurality of clients. As shown in FIG. 2, an IP sharing communication mechanism restricts the bandwidth occupied by the P2P transmission applications to no more than 20% of the total available bandwidth. However, the improved IP sharing communication mechanism shown in FIG. 2 has a disadvantage. That is, if the clients supported by the improved IP sharing communication mechanism do not execute other applications, all 80% of the total available bandwidth reserved for other applications are wasted, and all of the clients are forced to share the 20% of the total available bandwidth.

Therefore, there is a need for a new method for managing an Internet protocol sharing communication mechanism, which can reasonably assign the shared network connection resources and bandwidth to meet the clients' requirements. The present invention provides such methods.

### SUMMARY OF THE INVENTION

The present invention discloses an antenna apparatus, which uses an extending layer such that the antenna apparatus exhibits characteristics of a dipole antenna. Accordingly, the efficiency of the antenna apparatus is improved.

The method for managing an Internet protocol sharing communication mechanism according to one embodiment of the present invention comprises the steps of: setting up a plurality of rules for an Internet protocol sharing communication mechanism; providing a schedule divided into different time slots; assigning one rule from the rules for the Internet protocol sharing communication mechanism to each time slot of the schedule; and conducting a network communication according to the assigned rules.

The method for managing an Internet protocol sharing communication mechanism according to another embodiment of the present invention comprises the steps of: gathering statistics of network traffic for each of a plurality of clients; assigning network usage priorities to the clients according to the gathered statistics, wherein the clients of fewer network traffic are assigned higher network usage priorities; and conducting network communications for each of the plurality of clients according to the assigned network usage priorities.

### BRIEF DESCRIPTION OF THE DRAWINGS

The objectives and advantages of the present invention will become apparent upon reading the following description and upon referring to the accompanying drawings of which:

FIG. 1 shows a network bandwidth shared by a plurality of clients;

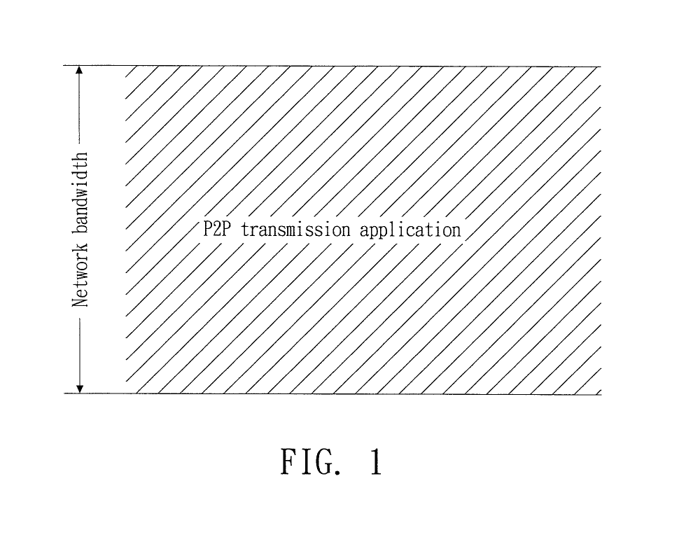

FIG. 2 shows another network bandwidth shared by a plurality of clients;

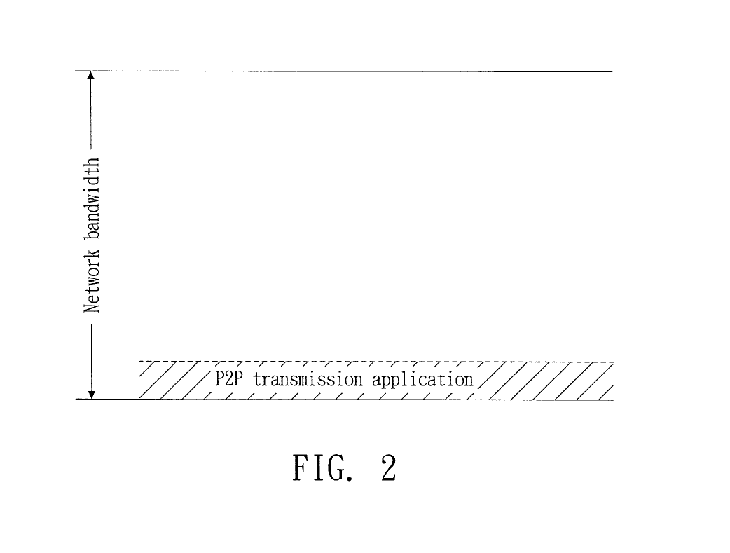

FIG. 3 shows a flowchart of the method for managing an Internet protocol sharing communication mechanism according to one embodiment of the present invention;

FIG. 4 shows the relation between a schedule and rules for an Internet protocol sharing communication mechanism according to one embodiment of the present invention;

FIG. 5 shows a flowchart of the method for managing an Internet protocol sharing communication mechanism according to another embodiment of the present invention; and

FIG. 6 shows the relation between network traffic and priorities according to one embodiment of the present invention.

### DETAILED DESCRIPTION OF THE INVENTION

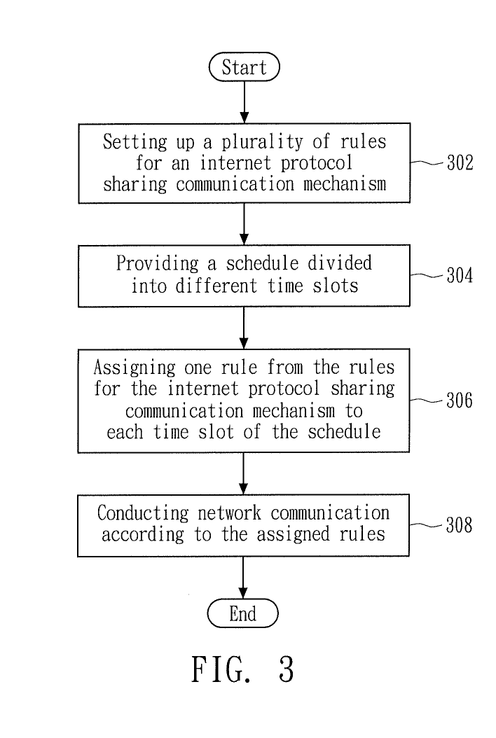

FIG. 3 shows a flowchart of the method for managing an Internet protocol sharing communication mechanism according to one embodiment of the present invention. In step 302, a plurality of rules is set up for an Internet protocol sharing communication mechanism, and step 304 is executed. In some embodiments of the present invention, these rules comprise rules of Internet usage priorities and bandwidth percentage assignment for different applications. In step 304, a schedule divided into different time slots according to weekdays and holidays is provided, and step 306 is executed. In step 306, each time slot of the schedule is assigned one rule from the rules for the Internet protocol sharing communication mechanism, and step 306 is executed. In step 308, a network communication is conducted according to the assigned rules.

The following exemplifies managing network connection resources based on the management method shown in FIG. 3. In step 302, three rules are set up for different applications. Rule 1 is an optimization rule for P2P transmission applications, such as opening a DMZ port. Rule 2 is to preserve 50 sessions and 50% of the total bandwidth for e-mail applications and preserve 200 sessions and 30% of the total bandwidth for Hypertext Transfer Protocol (HTTP) applications. Rule 3 is to preserve 300 sessions and 60% of the total bandwidth for gaming applications, message delivering applications, such as Microsoft MSN application, and web-phone applications, such as Skype.

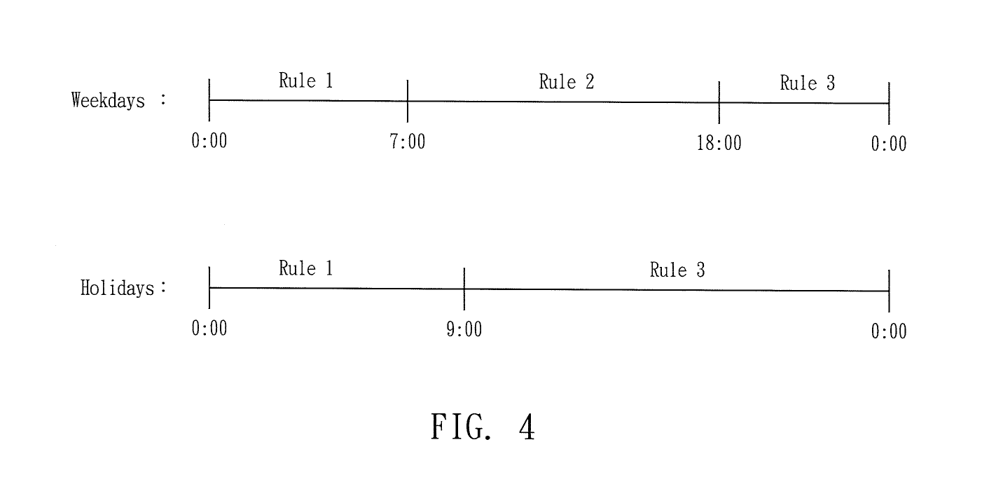

In step 304, a schedule is provided. The schedule can be divided into different time slots according to weekdays and holidays, as shown in FIG. 4. On weekdays, the time slots include a midnight time from midnight to 7:00 AM, working hours from 7:00 AM to 6:00 PM, and night time from 6:00 PM to midnight. On holidays, the time slots include a midnight time from midnight to 9:00 AM and a non-midnight time from 9:00 AM to midnight.

In step 306, each time slot of the schedule is assigned one rule from the rules for the Internet protocol sharing communication mechanism. Since the e-mail applications and the HTTP applications are more frequently used during the working hours on weekdays, this embodiment applies Rule 2 to assign most of the network resources and bandwidth to these two kinds of applications. On the other hand, since the entertainment applications are more frequently used during the night time on weekdays, this embodiment applies Rule 3 to assign most of the network resources and bandwidth to this kind of entertainment applications. In addition, since most users are at rest during midnight time on weekdays, this embodiment applies Rule 1 to P2P transmission applications which occupy most of the network bandwidth.

On holidays, most people will get up late. Therefore, the time slots on holidays include a midnight time from midnight to 9:00 AM and a non-midnight time from 9:00 AM to midnight. Similarly, during the midnight time, Rule 1 can be applied to assign most of the network resources and bandwidth to P2P transmission applications which occupy most of the network bandwidth. During the non-midnight time, Rule 3 can be applied to assign most of the network resources and bandwidth to entertainment applications.

In step 308, a network communication is conducted according to the assigned rules. Accordingly, by applying the method for managing an Internet protocol sharing communication mechanism, the network resources and bandwidth can be shared more reasonably based on users' habits in different time slots.

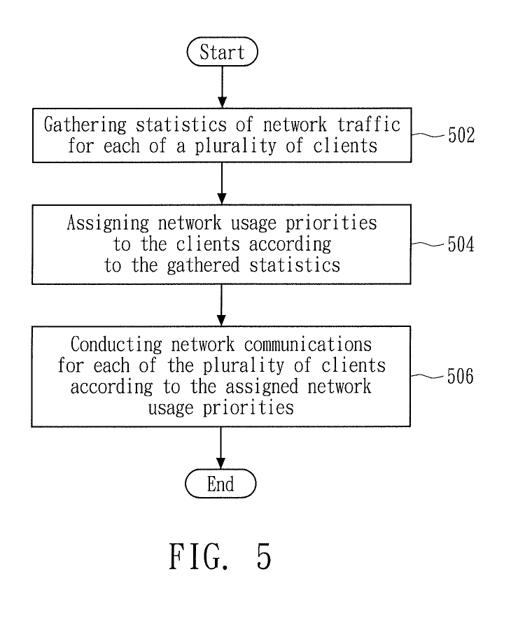

FIG. 5 shows a flowchart of the method for managing an Internet protocol sharing communication mechanism according to another embodiment of the present invention. In step 502, statistics of network traffic are gathered for each of a plurality of clients, and step 504 is executed. In step 504, network usage priorities for the clients are assigned according to the gathered statistics, and step 506 is executed, wherein the clients generating less network traffic are assigned higher network usage priorities. In step 506, network communications for each of the plurality of clients are conducted according to the assigned network usage priorities.

The following exemplifies managing network connection resources based on the management method shown in FIG. 5. In step 502, statistics of network traffic are gathered for each of a plurality of clients. In this embodiment, statistics of network traffic for each of the plurality of clients in one day are gathered. In step 504, network usage priorities for the clients are assigned according to the gathered statistics. In this embodiment, the amount of network traffic is classified in three levels based on two thresholds. If the network traffic of a client is lower than a first traffic level, this client is assigned a high network usage priority. If the network traffic of a client is higher than the first traffic level and lower than a second traffic level, this client is assigned a medium network usage priority. If the network traffic of a client is higher than the second traffic level, this client is assigned a low network usage priority.

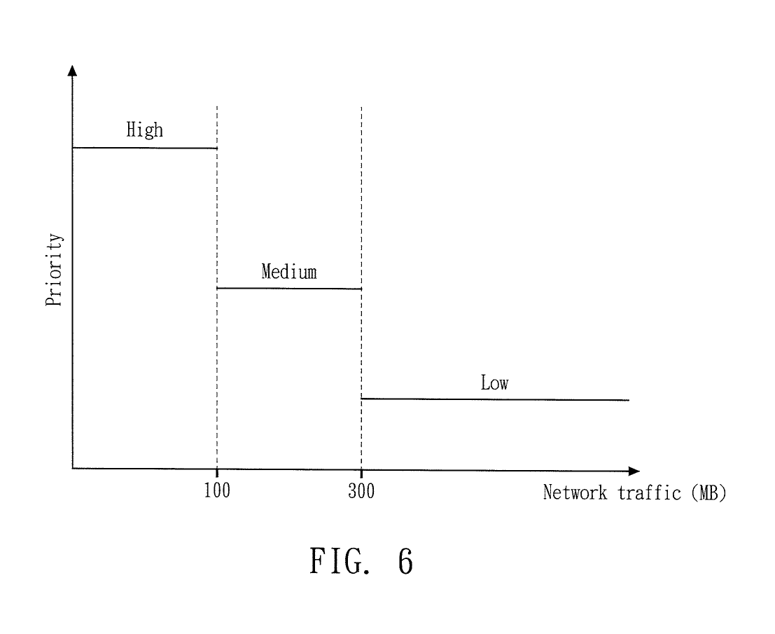

FIG. 6 shows the relation between network traffic and priorities according to this embodiment. As shown in FIG. 6, the first threshold is 100 MB and the second threshold is 300 MB.

In step 506, network communications for each of the plurality of clients are conducted according to the assigned network usage priorities. In this embodiment, the client assigned with the high network usage priority is assigned 500 sessions, and its packets to be delivered are processed in top priority. The client assigned with the medium network usage priority is assigned 300 sessions, and its packets to be delivered are processed if the client assigned with the high network usage priority does not transmit packets at the same time. The client assigned with the low network usage priority is assigned 100 sessions, and its packets to be delivered are processed if the clients assigned with the high and medium network usage priorities do not transmit packets at the same time. Accordingly, if a client is assigned fewer network resources and bandwidth on one day, it will be assigned more network resources and bandwidth the next day. Likewise, if a client is assigned more network resources and bandwidth on one day, it will be assigned fewer network resources and bandwidth the next day. In the long run, regardless of favorite application, each client will be assigned the same network resources and bandwidth, and a reasonable and fair Internet protocol sharing communication mechanism management is achieved.

The above-described embodiments of the present invention are intended to be illustrative only. Those skilled in the art may devise numerous alternative embodiments without departing from the scope of the following claims.

What is claimed is:

1. A method for managing an Internet protocol sharing communication mechanism, comprising the steps of:
setting up a plurality of rules for an Internet protocol sharing communication mechanism;
providing a schedule divided into different time slots;
assigning at least one of the rules for the Internet protocol sharing communication mechanism to each time slot of the schedule; and
conducting a network communication according to the assigned rules.

2. The method of claim 1, wherein the rules for an Internet protocol sharing communication mechanism comprise rules of network usage priorities and bandwidth percentage assignment for different applications.

3. The method of claim 2, wherein the applications comprise peer to peer transmission applications.

4. The method of claim 3, wherein one of the rules for an Internet protocol sharing communication mechanism is an optimization rule for peer to peer transmission applications.

5. The method of claim 3, wherein the schedule is divided into different time slots according to weekdays and holidays, and the peer to peer transmission applications have higher network usage priorities and bandwidth percentage assignment in time slots of weekday and holiday midnights.

6. The method of claim 2, wherein the applications comprise e-mail applications and Hypertext Transfer Protocol (HTTP) applications.

7. The method of claim 6, wherein the schedule is divided into different time slots according to weekdays and holidays, and the e-mail applications and the HTTP applications have higher network usage priorities and bandwidth percentage assignment in time slots of weekday working hours.

8. The method of claim 2, wherein the applications comprise gaming applications, message delivering applications and web-phone applications.

9. The method of claim 8, wherein the schedule is divided into different time slots according to weekdays and holidays, and the gaming applications, the message delivering applications and the web-phone applications have higher network usage priorities and bandwidth percentage assignment in time slots of weekday night times and holiday non-midnight times.

10. A method for managing an Internet protocol sharing communication mechanism, comprising the steps of:
gathering statistics of network traffic for each of a plurality of clients;
assigning network usage priorities to the clients according to the gathered statistics, wherein the clients of fewer network traffic are assigned higher network usage priorities; and
conducting network communications for each of the plurality of clients according to the assigned network usage priorities.

11. The method of claim 10, wherein the gathering step is to gather statistics of network traffic for each of the plurality of clients in one day.

12. The method of claim 10, wherein the amount of network traffic is classified in different levels based on a plurality of thresholds.

13. The method of claim 12, wherein a first client is assigned a high network usage priority if the network traffic of the first client is lower than a first traffic level, a second client is assigned a medium network usage priority if the network traffic of the second client is higher than the first traffic level and lower than a second traffic level, and third client is assigned a low network usage priority if the network traffic of the third client is higher than the second traffic level.

14. The method of claim 13, wherein packets to be transmitted from the client assigned the high network usage priority are processed in top priority.

15. The method of claim 13, wherein packets to be transmitted from the client assigned the medium network usage priority are processed if the client assigned the high network usage priority does not transmit packets at the same time.

16. The method of claim 13, wherein packets to be transmitted from the client assigned the low network usage priority are processed if the clients assigned the high and medium network usage priorities do not transmit packets at the same time.
